(19) United States
(12) Patent Application Publication
(10) Pub. No.: US 2002/0167701 A1
(43) Pub. Date: Nov. 14, 2002

(54) Optical transmission apparatus employing an illumination light

(76) Inventor: Shoji Hirata, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/107,635

(22) Filed: Mar. 27, 2002

(30) Foreign Application Priority Data
Mar. 28, 2001 (JP) P2001-092627

(51) Int. Cl. H04B 10/00

(52) U.S. Cl. 359/172; 359/154

(57) ABSTRACT

An illumination light source such as LED illumination light is modulated by information supplied from a personal computer. The illumination light is thereby modulated and transmits the information. Then the illumination light is received by a light receiving device, and is demodulated to drive an apparatus such as a printer connected to the light receiving device to print the information.

### CROSS REFERENCE TO RELATED APPLICATIONS

This application claims priority from Japanese Priority Document No. 2001-092627, filed on Mar. 28, 2001 with the Japanese Patent Office, which document is hereby incorporated by reference.

### BACKGROUND OF THE INVENTION

1. Field of the Invention

This invention relates to an optical transmission apparatus and particularly relates to such optical transmission apparatus employing an illumination light in an optical transmission system.

2. Description of the Related Art

An optical transmission system for transmitting information by light through a free space has been proposed. For example, as described in the Laid-open Japanese Patent OP-H6-37720, a method for transmitting a modulated infrared ray signal by assembling an infrared ray emitting device in a fluorescent light apparatus provided at a ceiling as an illumination means for a room. Thereby, it become possible to transmit information by providing a signal transmitting section at the ceiling that is suitable for a light emitting section of the optical transmission system.

Conventional optical transmission apparatus usually uses infrared rays and its service area is difficult to be recognized by human eyes, so that a transmitting operation thereof frequently failed. Further it is invisible in spite of emitting a powerful light, such powerful infrared ray has a fear to damage human eyes. Further at this time, necessity for setting infrared LED (Light Emitting Diode) only for the optical transmission in a home or the like is very small and a growing rate for such transmission system is expected to be very small.

But, recently the development of the LED has been progressed and high-intensity type LEDs and emitting various colors have been developed. These LEDs are applied to illumination and display, and accordingly it is possible to apply these LEDs to illumination purpose but also to optical transmission purpose effectively.

As described above, in the conventional optical transmission system, it is common to use an infrared ray as a light source, but it is very difficult to determine a transmission path because of invisible light, and further a danger to damage human eyes exists.

### SUMMARY OF THE INVENTION

According to the present invention, realization of an optical transmission system is performed with relatively simple way, where a transmission area is made clear, an interference of transmission is small, communication and illumination are commonly applied to simplify such infrastructure, and utilization of safe and widely usable are available.

Accordingly, a first aspect of the present invention is to provide an optical transmission apparatus that comprises: an illumination light source; a power source means for supplying power to the illumination light source; a modulation means for modulating wave forms of the power supplied from the power source means to the illumination light source in response to the information; a signal transmitting apparatus for transmitting a modulated illumination light obtained from the illumination light source; a signal receiving means for receiving the modulated illumination light from the illumination light source; and a receiving apparatus having a demodulating means to demodulate the information out of the modulated illumination light received by the signal receiving means.

A second aspect of the present invention is to provide the optical transmission apparatus wherein the illumination light source comprises of a plurality of monochromatic color light sources each having different peak spectrum in frequency.

A third aspect of the present invention is to provide the optical transmission apparatus wherein the illumination light source comprises of three monochromatic color light sources corresponding to three primary colors.

A forth aspect of the present invention is to provide the optical transmission apparatus wherein the three monochromatic color light sources are applied modulation process by the modulation means each depending on respective independent information; the signal receiving means receives the modulated illumination light by separating to respective monochromatic color light; and the demodulating means demodulates the respective independent information out of the respective monochromatic color light received and separated by the signal receiving means. Thereby, it is possible to carry out the WDM (Wavelength Division Multiplexing) communication using a white colored illumination light source comprising of three primary colors as information transmitting apparatus, and such optical transmission can be carried out efficiently.

In a fifth aspect of the present invention, LEDs are employed as illumination light source, and thereby it becomes possible to use higher modulation frequency and to carry out the modulation without recognizing flicker, as an illumination light.

According to a sixth aspect of the present invention, a transmission device for an optical transmission apparatus for transmitting information by employing light through a free space comprises: an illumination light source; a power source means for supplying power to the illumination light source; a modulation means for modulating wave forms of said power supplied from said power source means to the illumination light source in response to the information; and a signal transmitting apparatus for transmitting a modulated illumination light obtained from the illumination light source.

According to the present invention, it is possible to expect following merits by applying the LED illumination light sources to an optical transmission system.

1. It is not necessary to provide another LED light source for an optical transmission in addition to the illumination light source;

2. The transmission area is made clear by the illumination light;

3. It is possible to carry out so-called WDM communication by carrying respective information on three primary color lights;

4. It is possible to relatively freely arrange a communication related apparatus for the optical communication apparatus within a room;

5. It is possible to transfer information and data to a user even outside or a public display space; and

6. It is easily realized to communicate between rooms by selecting positions of the information terminals.

### BRIEF DESCRIPTION OF THE DRAWINGS

The above and other aspects, features and advantages of the present invention will become more apparent to those skilled in the art from the following description of the presently preferred exemplary embodiments of the invention taken in conjunction with the accompanying drawings, in which:

FIG. 1 shows a schematic diagram for one embodiment of an optical transmission apparatus according to the present invention;

FIG. 2 is a circuit diagram showing a signal transmitting section and a signal receiving section of the present invention; and

FIG. 3 is a block diagram showing a configuration of an embodiment for carrying out a WDM (Wave-length Division Multiplexing) in the present invention.

### DETAILED DESCRIPTION OF THE PREFERRED EMBODIMENTS

Here-in-after, an optical transmission system of the present invention is described with reference to the accompanying drawings in detail.

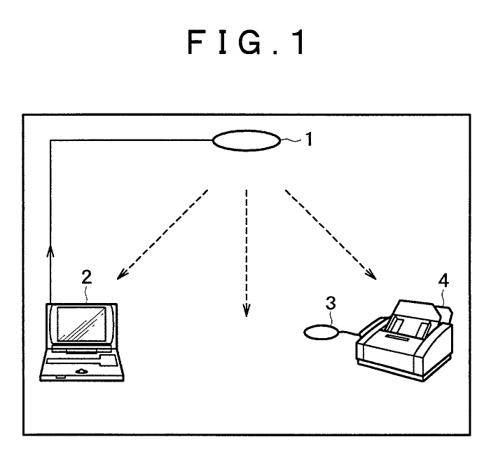

FIG. 1 shows a schematic diagram showing one of embodiments of an optical transmission system of the present invention used in doors such as at home. In FIG. 1, numeral 1 is a LED (Light Emitting Diode) illumination light, 2 is a personal computer, 3 is a light receiving device, and 4 is a printer, respectively. In this embodiment of the present invention, information from the personal computer 2 is transferred to the printer 4 to print the information through an optical transmission system comprising of the LED illumination light 1 and the light receiving device 3.

The LED illumination light 1 used for illumination purpose is, for example, hung down from a ceiling of a room. The LED is possible to use a higher modulation frequency among illumination light sources, and a modulation limit of a high speed LED reaches almost up to 50 MHz. Accordingly, in this invention, the LED light source is employed as an illumination light, and simultaneously the LED is intensity-modulated by the information so as for flicker not to be recognized by human eyes. And thus modulated illumination light is received by the light receiving device 3 and drives an apparatus such as the printer 4 connected to the light receiving device 3. The light receiving device 3 is a photo diode, for example. Thereby, effective light detection can be possible with a small-sized apparatus.

Further, FIG. 1 shows a situation where a connection line for modulating the LED illumination light 1 is provided at a modulation input terminal of the room. If this terminal is standardized such as the IEEE 1394 standard, it is possible to transmit various information in the room from the LED illumination light 1 of the ceiling, thereby the modulated signal can be received at any illuminated place of the room and can be obtained the various information. The LED illumination light 1 is provided on the ceiling, so that it is possible to have more wide freedom for a place to set the light receiving device 3.

Further FIG. 1 shows the case where the modulation input terminal and the LED illumination light 1 are connected by the connection line, but an infrared LED communication can be used, instead of the connection line. Further a storage means for storing information including modulation signal is provided at the illumination light source. In this case, when information from another signal source is supplied during transmission by the illumination light source, such information from another signal source can be temporary stored in the storage means.

Further, in a case where a signal from another optical transmission system is superposed and a received signal is not strong enough because of worse S/N ratio of the received signal, the modulation signal from the illumination light source may be made strong when the light receiving device provided at the illumination light source receives a signal designating the weakness of the receiving signal issued from the receiving means with the infrared LED.

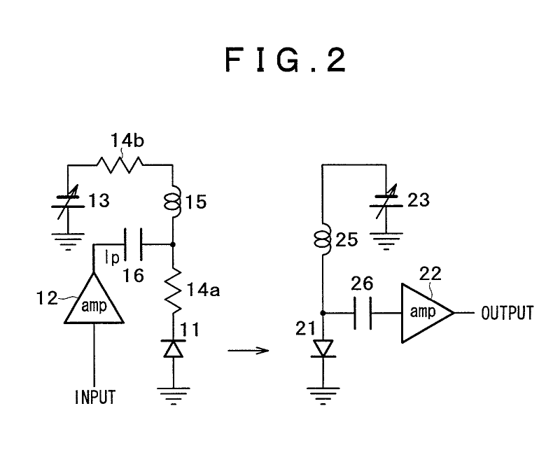

FIG. 2 shows one example of constructions of a signal transmitting section and a signal receiving section of the present invention. In FIG. 2, a numeral 11 is a LED (Light Emitting Diode), 12 is an amplifier, 13 is a power source for an illumination light, 14a and 14b are resistors, 15 is an inductor, 21 is a PD (Photo Diode), 22 is an amplifier, 23 is a power source, 25 is a inductor, and 26 is a capacitor, respectively.

The signal transmitting section includes a general-purpose LED modulation circuit and a transmitting signal is supplied from an input terminal to the LED modulation circuit by way of the amplifier 12. In order to avoid interference, it is preferable to use an input signal reception enable switch at the amplifier 12. A modulation light is received by the PD 21 of the light receiving device at the light receiving section, but a wave-length filter of the LED wave-length is effective in order to improve the S/N ratio. The received light is converted into an electric signal by the PD 21, and derived after being wave-formed to a signal level usable by the amplifier 22, a filter or the like.

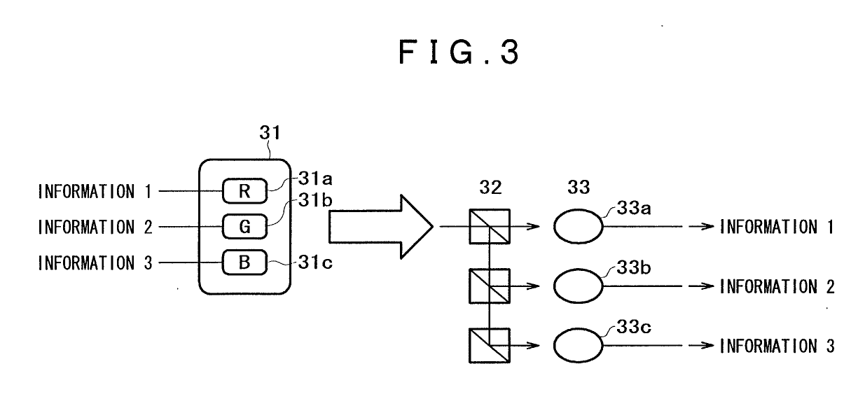

FIG. 3 shows another embodiment of the present invention where a WDM (Wave-length Division Multiplexing) is carried out. In FIG. 3, a numeral 31 is a white LED, 31a is a red LED, 31b is a green LED, 31c is a blue LED, 32 is a dichroic mirror, 33 is a light receiving device, 33a is a red light receiving device, 33b is a green light receiving device and 33c is a blue light receiving device, respectively.

In the white color LED, there are two types. One is a type where fluorescent material is excited by an ultra-violet ray to emit white light, and the other is a type to emit a white light by wave-mixing of respective output lights of red, green and blue primary color LEDs. In this embodiment of the present invention, an example of the WDM by applying these three primary color LEDs is disclosed. Independent information 1, 2 and 3 are respectively injected by current to respective three primary color LEDs 31a, 31b and 31c, and modulate these lights. These lights are whitened as an illumination light and also are used to illuminate the room.

In the light receiving devices, these three primary color lights are separated by a wave-length discriminator and supplied to respective light receiving devices 33a, 33b and 33c. As respective information 1, 2 and 3 are able to be obtained from these light receiving devices 33a, 33b and 33c, and thereby, the optical WDM transmission can be realized by applying the white LED illumination light. According to this embodiment of the present invention, three times of information than normal system can be transferred and further improvement of the S/N ratio can be expected by using wave-length selection filter.

Such red LED, green LED and blue LED are fabricated using following materials, for example. In order to fabricate the red LED, compound semiconductor material of AlGaInP system can be used, and by adjusting composition of the materials, it is possible to fabricate a LED for emitting a red light of 650 nm in a main peak wave-length. In order to fabricate the green LED, compound semiconductor material of AlGaInN system can be used, and by adjusting composition of the materials, it is possible to fabricate a LED for emitting a green light of 530 nm in a main peak wave-length. Further in order to fabricate the blue LED, compound semiconductor material of AlGaInN system can be used, and by adjusting composition of the materials, it is possible to fabricate a LED for emitting a blue light of 450 nm in a main peak wave-length.

In the above described example, the illumination light source is constructed by applying optical three primary colors, but the illumination light source may be constructed without using optical three primary colors. Further if they are monochromatic color light sources of different wave-length, combination of two single monochromatic color light sources, 4 or more than 4 monochromatic color light sources can be applied.

According to the present invention, the optical transmission apparatus can be used out of doors. For example, in a case where a traffic sign is constructed with LEDs, traffic information can be obtained through the receiving light from the traffic sign by car or pedestrian while superposing the traffic information by modulation on the light of the traffic sign. The light receiving device is mounted in a car or on a PDA (Personal Digital Assistants) such as a mobile phone. This application was not available by the conventional traffic sign. The present invention can be applied at a display booth of a fair, an article on exhibition is illuminated by the LED, and the illumination light from the LED is modulated with explanation for the article on exhibition. Thereby, each visitor can listen to the explanation for the particular article on exhibition only by aiming the light receiving device to the article. In this case, if data for the explanation for the particular article on exhibition is modulated in a compressed form, transmission of such data is finished in a short time.

Large-sized screen displays used out of doors have been increased gradually, and if the modulation signals are independently supplied to respective lights for red, green and blue colors, it is possible for a visitor to receive such three channels of signals by aiming the light receiving device to the display. Accordingly, if music data or other data are modulating the lights, a user can get information not recognized by others and this is expected to be popular among young people and young ladies.

Accordingly, the present invention thought to be a space transmission by the illumination LED within doors are applied to an illumination light or the like to the illumination lights for out of doors, it is able to transfer various data through wide space of outdoors.

What is claimed is:

1. An optical transmission apparatus for transmitting and receiving information by employing light through a free space comprising:
an illumination light source;
a power source means for supplying power to said illumination light source;
a modulation means for modulating wave forms of said power supplied from said power source means to said illumination light source in response to said information;
a signal transmitting apparatus for transmitting a modulated illumination light obtained from said illumination light source;
a signal receiving means for receiving said modulated illumination light from said illumination light source; and
a signal receiving apparatus having a demodulating means to demodulate said information out of said modulated illumination light received by said signal receiving means.

2. The optical transmission apparatus as cited in claim 1, wherein
said illumination light source comprises of a plurality of monochromatic color light sources each having different peak spectrum in frequency.

3. The optical transmission apparatus as cited in claim 2, wherein
said illumination light source comprises of three monochromatic color light sources corresponding to three primary colors.

4. The optical transmission apparatus as cited in claim 3, wherein
said three monochromatic color light sources are applied modulation process by said modulation means each depending on respective independent information;
said receiving means receives said modulated illumination light by separating to respective monochromatic color light; and
said demodulating means demodulates said respective independent information out of said respective monochromatic color light received and separated by said signal receiving means.

5. The optical transmission apparatus as cited in claim 1, wherein
said illumination light source is a light emitting diode device.

6. The optical transmission apparatus as cited in claim 1, wherein
said signal receiving means is a photo diode device.

7. A transmission device for an optical transmission apparatus for transmitting information by employing light through a free space comprising:
an illumination light source;
a power source means for supplying power to said illumination light source;
a modulation means for modulating wave forms of said power supplied from said power source means to said an illumination light source in response to said information; and
a signal transmitting apparatus for transmitting a modulated illumination light obtained from said illumination light source.
